(19) United States
(12) Patent Application Publication
(10) Pub. No.: US 2019/0004514 A1
(43) Pub. Date: Jan. 3, 2019

(54) DRIVER ASSISTANCE APPARATUS AND DRIVER ASSISTANCE METHOD

(71) Applicant: DENSO TEN Limited, Kobe-shi (JP)

(72) Inventors: Junko HIWATASHI, Kobe-shi (JP); Kaori HONDA, Kobe-shi (JP); Tatsuki KUBO, Kobe-shi (JP)

(73) Assignee: DENSO TEN Limited, Kobe-shi (JP)

(21) Appl. No.: 15/921,009

(22) Filed: Mar. 14, 2018

(30) Foreign Application Priority Data
Jun. 29, 2017 (JP) 2017-127902

(51) Int. Cl. G05D 1/00; B60K 35/00; G09G 5/00

(52) U.S. Cl. CPC G05D 1/0061; B60K 35/00; G09G 5/003; G06K 9/00221; B60K 2350/962; B60K 2350/352; B60K 2350/1096; G05D 1/0088

(57) ABSTRACT

A driver assistance apparatus includes a driving switching unit and a display controlling unit. The driving switching unit switches a driving state of a vehicle from autonomous driving into manual driving. The display controlling unit causes, before the driving switching unit switches the driving state of the vehicle from the autonomous driving into the manual driving, a display to display an image that transitions from a vehicle image imitating an exterior of the vehicle into an interior image imitating an interior of the vehicle.

### CROSS-REFERENCE TO RELATED APPLICATION

This application is based upon and claims the benefit of priority of the prior Japanese Patent Application No. 2017-127902, filed on Jun. 29, 2017, the entire contents of which are incorporated herein by reference.

### FIELD

The embodiment discussed herein is directed to a driver assistance apparatus and a driver assistance method.

### BACKGROUND

Conventionally, there has been known a driver assistance apparatus that assists a driver in driving a vehicle (see Japanese Laid-open Patent Publication No. H08-102000, for example). This driver assistance apparatus performs, for example, autonomous driving control that requires no driving operation of the driver and cruise control for keeping a vehicle speed, an inter-vehicle distance, etc. constant.

Meanwhile, when the above-mentioned autonomous driving is released, a driving state of the vehicle is changed into manual driving that requires driving operations of the driver, for example. The driver is to perform a driving preparation operation before the change into the manual driving, such as an operation of gripping a steering wheel.

Thus, the driver assistance apparatus is configured to cause the driver to previously recognize the change into the manual driving. However, the conventional technology has room for improvement in effectively causing a driver to recognize the change into the manual driving.

### SUMMARY

A driver assistance apparatus according to an aspect of an embodiment includes a driving switching unit and a display controlling unit. The driving switching unit switches a driving state of a vehicle from autonomous driving into manual driving. The display controlling unit causes, before the driving switching unit switches the driving state of the vehicle from the autonomous driving into the manual driving, a display to display an image that transitions from a vehicle image imitating an exterior of the vehicle into an interior image imitating an interior of the vehicle.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram illustrating an outline of a driver assistance method according to an embodiment;

FIG. 2 is a block diagram illustrating a configuration example of a driver assistance system according to the embodiment;

FIG. 3 is a diagram illustrating one example of a gaze guiding image;

FIG. 4 is a diagram illustrating a modification of the gaze guiding image;

FIG. 5 is a diagram illustrating one example of an image for causing a driver to recall a start of manual driving;

FIG. 6 is a diagram illustrating one example of a steering-wheel image;

FIG. 7 is a diagram illustrating one example of an image that indicates information on a remaining distance; and

FIG. 8 is a flowchart illustrating a processing procedure to be executed by a driver assistance apparatus.

### DESCRIPTION OF EMBODIMENT

Hereinafter, a driver assistance apparatus and a driver assistance method disclosed in the present application will be described in detail with reference to the accompanying drawings. Moreover, an embodiment described below is merely one example, and not intended to limit the present disclosure.

1. Outline of Driver Assistance Method

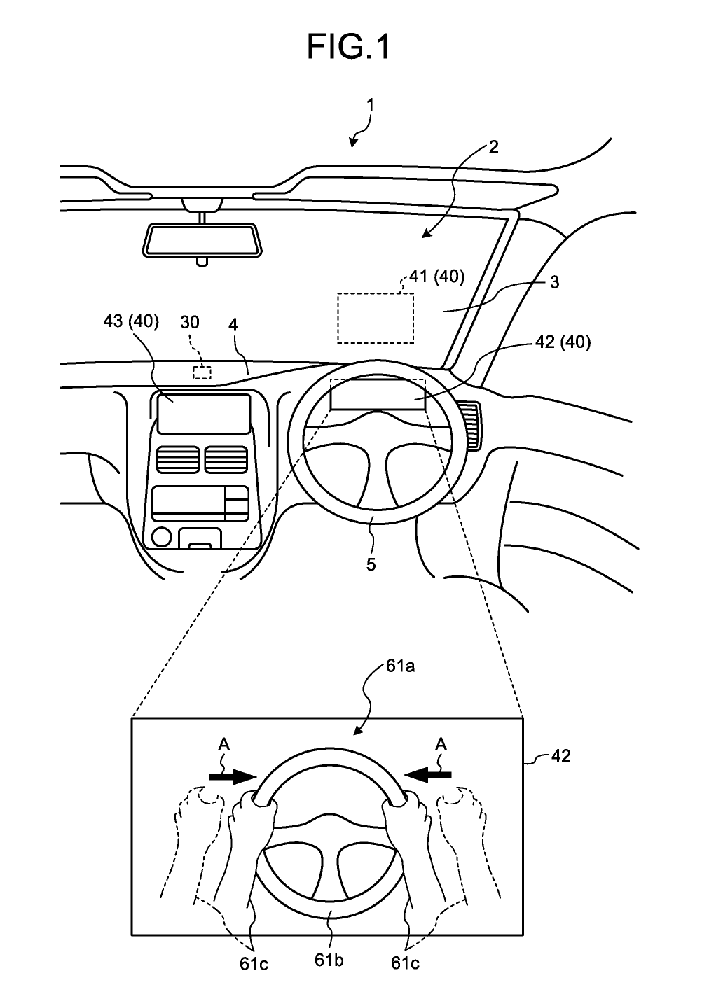

Hereinafter, an outline of a driver assistance method according to an embodiment will be explained with reference to FIG. 1. FIG. 1 is a diagram illustrating the outline of the driver assistance method according to the embodiment.

As illustrated in FIG. 1, the driver assistance method according to the present embodiment is performed by a driver assistance apparatus 30 provided in a vehicle 1 such as an automobile. In addition to the driver assistance apparatus 30, displays 40 are provided in the vehicle 1.

The number of the displays 40 is two or more; however, not limited thereto. In the example illustrated in FIG. 1, the number of the displays 40 is three, but not limited thereto, the number of the displays 40 may be equal to or less than two or equal to or more than four, for example.

Each of the displays 40 is a display that is able to display various kinds of information, such as information on a navigation device and an audio device, and information on driving situations including a vehicle speed and the like. For example, the displays 40 include; a head-up display 41 (hereinafter, may be referred to as “HUD 41”); a meter display 42; and a center display 43.

The HUD 41 is attached in an appropriate position of a vehicle interior 2 so as to display, on a windscreen 3 that is provided in the front part of the vehicle 1, an image including the information, for example. Thus, the HUD 41 is able to present the information within a viewing field of a driver (user) in driving.

The meter display 42 and the center display 43 are attached to an instrument panel 4 so as to display various kinds of information, for example. Specifically, the meter display 42 is attached to the instrument panel 4 on a back side of a steering wheel 5 and in the vicinity of the front of a driver's seat. The center display 43 is attached in a position corresponding to a space between the driver's seat and a front passenger's seat in the vicinity of the center of the instrument panel 4. The above-mentioned attached positions of the HUD 41, the meter display 42, and the center display 43 are merely one example, and not limited thereto.

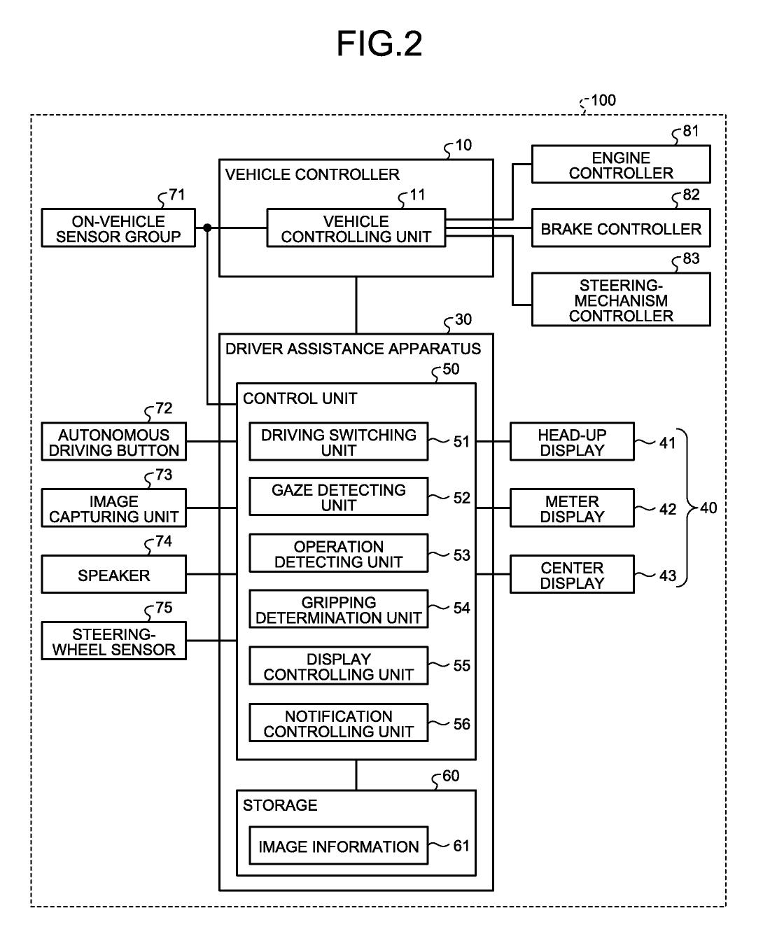

The driver assistance apparatus 30 controls the displays 40, and further performs control for assisting the driver in driving. The control for assisting the driver in driving is control for autonomous driving that requires no driving operation of the driver, for example. This autonomous driving may include other kinds of driver assistance control, such as “cruise driving” for controlling on the vehicle 1 so as to keep an inter-vehicle distance to a preceding vehicle (not illustrated) constant, and “lane keeping driving” for controlling the vehicle 1 so as to keep a travelling lane. Details of a configuration of the driver assistance apparatus 30 will be mentioned later with reference to FIG. 2.

Meanwhile, in a case where a condition for performing autonomous driving is satisfied, for example, when the vehicle 1 travels along a predetermined expressway, the driver assistance apparatus 30 performs autonomous driving. On the other hand, when the condition is not satisfied, the driver assistance apparatus 30 performs manual driving. Therefore, when the autonomous driving is released, a driving state of the vehicle 1 is to be switched into the manual driving, and thus the driver is to perform a driving preparation operation, such as gripping the steering wheel 5, before the driving state of the vehicle 1 is changed into the manual driving.

Thus, the driver assistance apparatus 30 according to the present embodiment is configured to be able to effectively cause the driver to previously recognize the change in the state of the vehicle 1 from the autonomous driving into the manual driving so as to urge the driver to perform the driving preparation operation. Hereinafter, details of this configuration will be explained.

As illustrated in FIG. 1, before the driving state of the vehicle 1 is switched from the autonomous driving into the manual driving, the driver assistance apparatus 30 causes, for example, the meter display 42 among the displays 40 to display a guidance image 61a for urging the driver to grip the steering wheel 5.

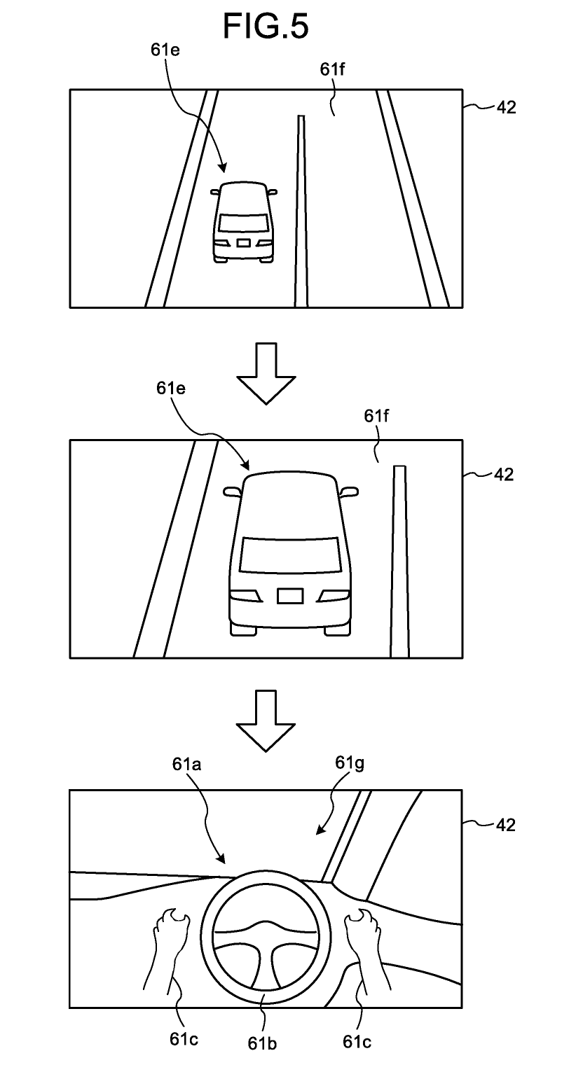

Furthermore, the driver assistance apparatus 30 is able to cause the meter display 42 to display an image that transitions from a vehicle image imitating the exterior of the vehicle 1 into an interior image imitating the interior of the vehicle 1, and then display this guidance image 61a. This point will be mentioned later with reference to FIG. 5.

The guidance image 61a includes a steering-wheel image 61b obtained by imitating the steering wheel 5 and a hand image 61c obtained by imitating hands of the driver, for example. In FIG. 1, the hand image 61c before the steering-wheel image 61b is gripped is illustrated by using two-dot chain lines. On the other hand, the hand image 61c in a state where the steering-wheel image 61b is gripped is illustrated by using solid lines.

As depicted by using arrows A, in the guidance image 61a, the driver assistance apparatus 30 moves the hand image 61c from positions of two-dot chain lines to positions of solid lines. In this manner, the guidance image 61a includes an image that indicates an operation of the hand image 61c for gripping the steering-wheel image 61b, so that it is possible to cause the driver to intuitively grasp that the driver is to perform a driving preparation operation for gripping the steering wheel 5 in preparation for the manual driving.

In this manner, the driver assistance apparatus 30 causes any of the displays 40 to display the guidance image 61a and the image (to be mentioned later) that transitions from the vehicle image into the interior image to be able not only to effectively cause the driver to previously recognize the change from the autonomous driving to the manual driving, but also to urge the driver to perform the driving preparation operation for gripping the steering wheel 5.

2. Configuration of Driver Assistance System Constituted of Driver Assistance Apparatus

Next, a configuration of a driver assistance system 100 constituted of the driver assistance apparatus 30 according to the embodiment will be explained with reference to FIG. 2. FIG. 2 is a block diagram illustrating a configuration example of the driver assistance system 100 according to the embodiment. In FIG. 2, configuration elements for explaining features according to the present embodiment are depicted by using functional blocks, and description of common configuration elements is omitted.

In other words, the configuration elements illustrated in FIG. 2 are functionally conceptual, and thus they are not to be physically configured as illustrated in the drawings. For example, specific forms of distribution and integration of the configuration elements are not limited to those illustrated in the drawings, and all or some of the devices can be configured by separating or integrating the apparatus functionally or physically in any unit, according to various types of loads, the status of use, etc.

As illustrated in FIG. 2, the driver assistance system 100 is constituted of, a vehicle controller 10, the driver assistance apparatus 30, the displays 40, an on-vehicle sensor group 71, an autonomous driving button 72, an image capturing unit 73, a speaker 74, a steering-wheel sensor 75, an engine controller 81, a brake controller 82, and a steering-mechanism controller 83.

The displays 40 has the HUD 41, the meter display 42, and the center display 43 as described above, but not limited thereto, may have another display such as a display attached to a ceiling of the vehicle interior 2 (see FIG. 1).

The on-vehicle sensor group 71 has various sensors that detect information needed for travelling control on the vehicle 1. For example, the on-vehicle sensor group 71 includes: a vehicle speed sensor that detects a vehicle speed; an accelerator sensor that detects an operation amount of an accelerator; a brake sensor that detects an operation amount of a brake; and an operated wheel-angle sensor that detects an operated wheel angle of the steering wheel 5, among other things.

The on-vehicle sensor group 71 further includes various devices that detect information needed for driver assistance control such as the autonomous driving of the vehicle 1. For example, the on-vehicle sensor group 71 includes: a Global Positioning System (GPS) reception apparatus that detects a present position of an own vehicle on the basis of signals sent from a GPS satellite; a radar that measures a distance to a target object and a direction of the target object on the basis of reflection waves obtained by radiating electromagnetic waves toward a target object such as another vehicle; and a camera that captures a target object such as another vehicle that exists in the outer side (vicinity) of the vehicle 1, among other things.

The on-vehicle sensor group 71 may include, not limited to the above-mentioned various devices, other devices such as (i) a vehicle-to-vehicle communication device that transmits and receives various kinds of information (for example, vehicle speed etc.) to and from another vehicle and (ii) a vehicle-to-road communication device that transmits and receives various kinds of information (for example, construction information of travelling road) to and from a communication device placed on a road shoulder.

The above-mentioned on-vehicle sensor group 71 outputs, to the vehicle controller 10 and the driver assistance apparatus 30, signals indicating the acquired vehicle speed and the acquired position of the own vehicle.

The autonomous driving button 72 is arranged at a position in the vehicle interior 2 (see FIG. 1) for which the driver is able to reach. The autonomous driving button 72 outputs in accordance with an operation of the driver, to the driver assistance apparatus 30, a signal that indicates a start request of autonomous driving and a signal that indicates a release request of the autonomous driving.

The image capturing unit 73 is arranged in an appropriate position in the vehicle interior 2 (see FIG. 1) so as to capture the driver. As mentioned later, the image capturing unit 73 is used for detecting a gaze of the driver and for detecting an operation of the driver on the steering wheel 5 so as to capture an image including a face and hands of the driver, and outputs this image information to the driver assistance apparatus 30. As the image capturing unit 73, an on-vehicle camera etc. may be employed.

The speaker 74 is arranged at a position in the vehicle interior 2 (see FIG. 1). The speaker 74 outputs a sound on information to the driver, which will be mentioned later.

The steering-wheel sensor 75 is attached to the steering wheel 5 (see FIG. 1), for example. As mentioned later, the steering-wheel sensor 75 is used for determining whether or not the driver grips the steering wheel 5. Thus, as the steering-wheel sensor 75, a vital sensor may be employed, which is able to detect the pulse, the blood pressure, and sweating of the driver when the driver grips the steering wheel 5.

The steering-wheel sensor 75 may be, not limited to the above-mentioned vital sensor, another-type sensor when the vital sensor is able to detect the gripping of the steering wheel 5 by the driver, such as (i) a pressure sensor that is able to detect the pressure that works on the steering wheel 5 when the driver grips the steering wheel 5 and (ii) a touch censor that is able to detect a contact of the driver with the steering wheel 5.

The vehicle controller 10 includes a vehicle controlling unit 11. The vehicle controlling unit 11 performs travelling control of the vehicle 1. Specifically, when the driver performs a driving operation on, for example, the accelerator (not illustrated), the brake (not illustrated), or the steering wheel 5, the accelerator sensor, the brake sensor, or the operated wheel-angle sensor of the on-vehicle sensor group 71 outputs various signals to the vehicle controlling unit 11.

The vehicle controlling unit 11 controls the engine controller 81, the brake controller 82, and the steering-mechanism controller 83 on the basis of the signals so as to perform the travelling control of the vehicle 1. The above-mentioned engine controller 81 includes a device for controlling the engine, the brake controller 82 includes a device for controlling the brake, and the steering-mechanism controller 83 includes a device for controlling a steering mechanism for steering the vehicle 1.

The driver assistance apparatus 30 includes a control unit 50 and a storage 60. The control unit 50 includes a driving switching unit 51, a gaze detecting unit 52, an operation detecting unit 53, a gripping determination unit 54, a display controlling unit 55, and a notification controlling unit 56, and is a microcomputer including a Central Processing Unit (CPU).

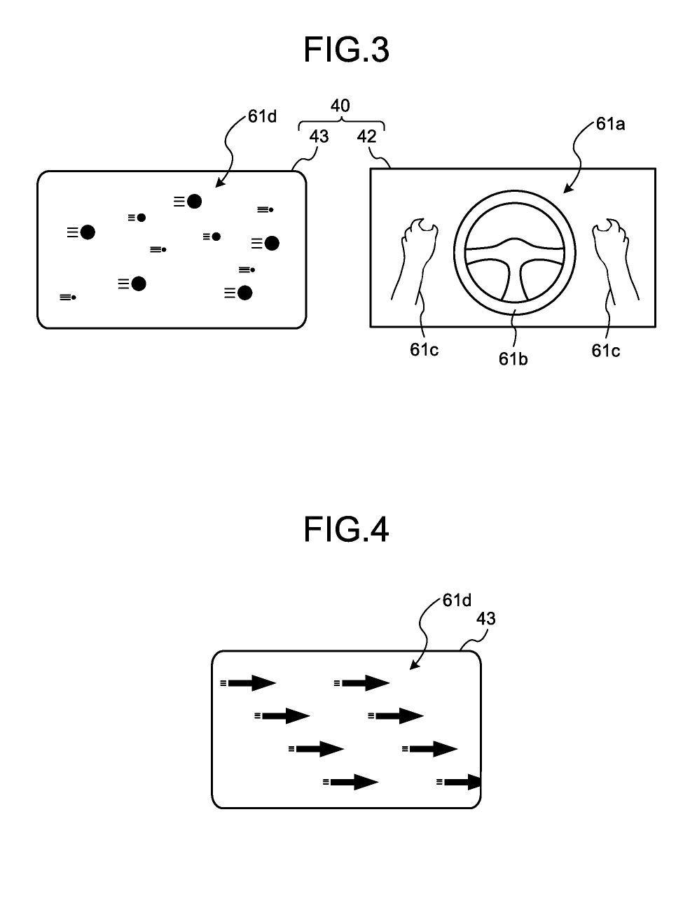

The storage 60 is a storage constituted of a storage device, such as a non-volatile memory and a hard disc drive, and stores image information 61. The image information 61 includes information on the above-mentioned guidance image 61a (see FIG. 1). The image information 61 further includes information on, in addition to the guidance image 61a, a gaze guiding image 61d (see FIG. 3), a vehicle image 61e, a road image 61f, an interior image 61g (see FIG. 5), etc. Details of these various images will be mentioned later.

The driving switching unit 51 switches a driving state of the vehicle 1 between autonomous driving and manual driving. For example, when a signal indicating a start request of the autonomous driving is input from the autonomous driving button 72, the vehicle 1 is travelling on a predetermined expressway, or the condition for performing the autonomous driving is satisfied, the driving switching unit 51 switches the driving state of the vehicle 1 into the autonomous driving. The driving switching unit 51 controls the engine controller 81 etc. via the vehicle controlling unit 11 on the basis of information of the GPS, information of the radar, or the like, which is output from the on-vehicle sensor group 71, for example, so as to perform the driver assistance control such as the autonomous driving.

For example, when the condition for performing the autonomous driving is not satisfied, the driving switching unit 51 switches a driving state of the vehicle 1 from the autonomous driving into the manual driving. The driving switching unit 51 outputs before an actual change into the manual driving, to the display controlling unit 55, information on a time interval from a present time point to a time point of the switching into the manual driving and a distance from a present position to a position at which a driving state of the vehicle 1 is switched into the manual driving. Hereinafter, the time interval until the time point of the switching into the manual driving may be referred to as “remaining time interval”, and the distance to the position at which the driving state of the vehicle 1 is switched into the manual driving may be referred to as “remaining distance”.

The driving switching unit 51 may determine, before the switching into the manual driving, whether or not the driver is able to normally perform the manual driving. When determining that the driver is not able to normally perform the manual driving, the driving switching unit 51 may cause the vehicle 1 to autonomously stop at a safe position such as a road shoulder and a service area.

Whether or not the driver is able to normally drive the vehicle 1 is determined, before the switching into the manual driving, by whether or not the driver is able to operate the steering wheel along a road curve in a case where the vehicle 1 is entering the road curve, for example; however, not limited thereto.

The gaze detecting unit 52 acquires an image of the driver that is captured by the image capturing unit 73, and executes an image analyzing process on this image so as to detect a gaze of the driver. For example, the gaze detecting unit 52 may compare a direction of the head or a position of an eye of the driver in the image of the driver with a reference image previously stored in the storage 60 so as to detect a direction of the gaze of the driver.

For example, the image capturing unit 73 may be configured to include an infrared camera and an infrared light emitting diode (LED), and the gaze detecting unit 52 may detect the gaze of the driver on the basis of an image captured by the infrared camera. Specifically, the gaze detecting unit 52 may detect the gaze of the driver on the basis of a positional relation between (i) a pupil in the infrared image that is obtained by capturing a face of the driver illuminated by the infrared LED by using the infrared camera and (ii) an infrared illuminated image reflected on his/her eyeball.

The gaze detecting unit 52 outputs information on the detected gaze of the driver to the display controlling unit 55. The above-mentioned method for detecting a gaze of a driver is merely one example, and not limited thereto.

The operation detecting unit 53 detects a driver's operation performed on the steering wheel 5. For example, the operation detecting unit 53 acquires an image of the driver that is captured by the image capturing unit 73, and executes an image analyzing process on this image so as to detect a driver's operation of bringing his/her hand toward the steering wheel 5.

When detecting the driver's operation of bringing his/her hand toward the steering wheel 5, the operation detecting unit 53 outputs, to the display controlling unit 55, information indicating an operation performed on the steering wheel 5, such as one or more hand positions of the driver with respect to the steering wheel 5.

The gripping determination unit 54 determines whether or not the driver grips the steering wheel 5, on the basis of the output of the steering-wheel sensor 75, for example. In a case where the steering-wheel sensor 75 includes a vital sensor, when the steering-wheel sensor 75 detects the pulse etc. of the driver, the gripping determination unit 54 is able to determine that the driver has gripped the steering wheel 5, for example. The gripping determination unit 54 outputs information indicating its determination result to the display controlling unit 55.

As described above, before a driving state of the vehicle 1 is switched from the autonomous driving into the manual driving, the display controlling unit 55 causes the displays 40 to display the guidance image 61a that urges the driver to grip the steering wheel 5.

The display controlling unit 55 is able to cause the meter display 42 that is arranged on the back side of the actual steering wheel 5, among the displays 40, to display the guidance image 61a. Thus, the display controlling unit 55 is able to display, in the vicinity of the actual steering wheel 5, the steering-wheel image 61b included in the guidance image 61a, so that it is possible to cause the driver to more intuitively grasp that the driver is to perform the driving preparation operation for gripping the steering wheel 5 in preparation for the manual driving.

The display controlling unit 55 may cause the HUD 41 and/or the center display 43, instead of or in addition to the meter display 42, to display the guidance image 61a.

When the driver is estimated not to look at the meter display 42, the display controlling unit 55 may cause the displays 40 to display the gaze guiding image 61d (see FIG. 3) that guides a gaze of the driver to the meter display 42. FIG. 3 is a diagram illustrating one example of the gaze guiding image 61d.

For example, as illustrated in FIG. 3, when the gaze detecting unit 52 detects that a gaze of the driver is directed to any of the displays 40 (for example, center display 43) other than the meter display 42, the display controlling unit 55 causes the center display 43 to display the gaze guiding image 61d. Here, the HUD 41 or the center display 43 is one example of “another display” with respect to the meter display 42 that displays the guidance image 61a.

The gaze guiding image 61d may include an image in which a dot pattern flows from the center display 43 to the meter display 42, for example. When the driver follows a motion of the dot pattern, the driver naturally directs his/her gaze to the meter display 42 from the center display 43. In other words, the gaze guiding image 61d is able to guide the gaze of the driver to the meter display 42.

In this manner, when the gaze detecting unit 52 detects that the driver directs his/her gaze to the center display 43 (one example of another display) other than the meter display 42 that displays the guidance image 61a, among the displays 40, the display controlling unit 55 causes the center display 43 to display the gaze guiding image 61d. Thus, it is possible to guide a gaze of the driver to the meter display 42 that displays the guidance image 61a.

Moreover, the display controlling unit 55 may cause the speaker 74 to output an effect sound. As the effect sound, an effect sound (for example, sparkling sound, smooth sound, etc.) that expresses a flow from the center display 43 to the meter display 42 may be employed, for example. Thus, it is possible to more effectively guide a gaze of the driver to the meter display 42 that displays the guidance image 61a.

When the gaze detecting unit 52 detects that the driver directs his/her gaze to the HUD 41, the display controlling unit 55 may cause the HUD 41 to display the gaze guiding image 61d so as to guide the gaze of the driver to the meter display 42 (not illustrated).

The gaze guiding image 61d is not limited to the example illustrated in FIG. 3. FIG. 4 is a diagram illustrating a modification of the gaze guiding image 61d. As illustrated in FIG. 4, the gaze guiding image 61d according to the modification may include an image in which an arrow pattern flows from the center display 43 to the meter display 42 (not illustrated in FIG. 4), for example. Thus, similarly to the gaze guiding image 61d illustrated in FIG. 3, it is possible to guide a gaze of the driver to the meter display 42 from the center display 43. The gaze guiding image 61d may include an image that indicates a sentence for guiding the gaze of the driver, such as “look at meter display”.

The display controlling unit 55 may cause, before the meter display 42 displays the guidance image 61a, the meter display 42 to display an image for causing the driver to recall a start of the manual driving, in other words, an image for effectively causing the driver to realize the switching into the manual driving. FIG. 5 is a diagram illustrating one example of an image for causing the driver to recall a start of the manual driving.

As illustrated in an upper part of FIG. 5, the display controlling unit 55 causes the meter display 42 to display the vehicle image 61e that imitates an exterior of the vehicle 1 (see FIG. 1). The vehicle image 61e is a bird's eye as viewed from an oblique upper backward position of the vehicle 1. The vehicle image 61e may be combined with the road image 61f that imitates a travelling road of the vehicle 1.

As illustrated in a middle part of FIG. 5, the display controlling unit 55 causes the meter display 42 to display an image in which a view point gradually approaches the vehicle image 61e. As illustrated in a lower part of FIG. 5, the display controlling unit 55 finally causes the meter display 42 to display the interior image 61g that imitates the vehicle interior 2 (see FIG. 1). As illustrated in FIG. 5, the display controlling unit 55 may combine the interior image 61g with the guidance image 61a to cause the meter display 42 to display them.

In this manner, the display controlling unit 55 causes the meter display 42 to display an image that gradually transitions from the vehicle image 61e into the interior image 61g to be able to display an image as if the driver slid into the driver's seat from the rear of the vehicle 1. Thus, the display controlling unit 55 is able to cause the driver to recall a start of the manual driving, in other words, the display controlling unit 55 is able to effectively cause the driver to realize the switching into the manual driving, so that it is possible to effectively urge the driver to perform the driving preparation operation for gripping the steering wheel 5, as a result.

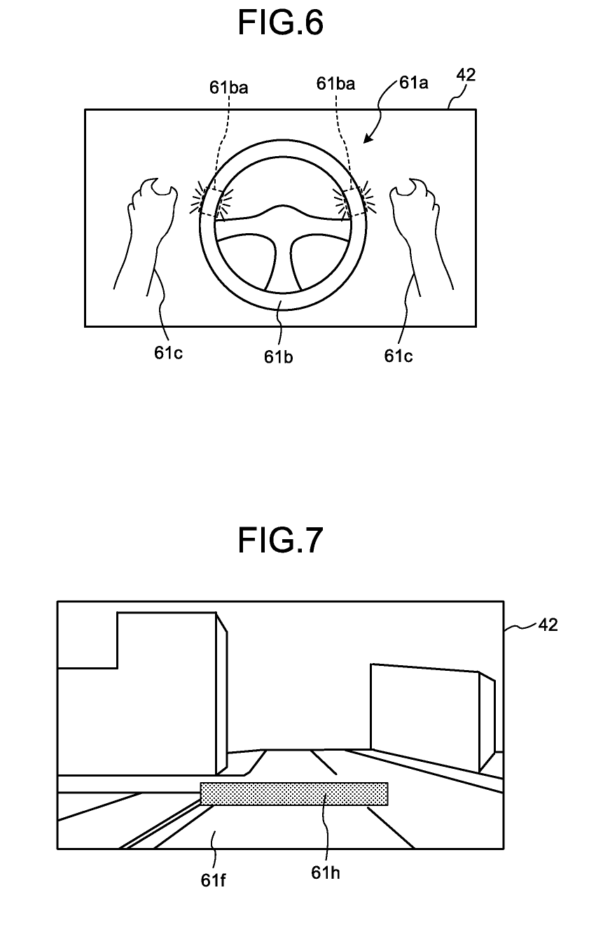

FIG. 6 is a diagram illustrating one example of the steering-wheel image 61b. As illustrated in FIG. 6, the display controlling unit 55 may emphasize and display, in the steering-wheel image 61b, the vicinity of positions (gripping positions) 61ba corresponding to portions of the steering wheel 5 to be gripped. In FIG. 6, the gripping positions 61ba are enclosed and indicated by using dashed lines.

For example, the display controlling unit 55 may emphasize and display the vicinity of the gripping positions 61ba in the steering-wheel image 61b by flashing, blinking, or changing color of them. Thus, the display controlling unit 55 is able to cause the gripping positions 61ba to be easily noticed, so that it is possible to effectively urge the driver to perform the driving preparation operation for gripping the steering wheel 5.

The display controlling unit 55 may change the guidance image 61a on the basis of an operation of the driver for the steering wheel 5 that is detected by the operation detecting unit 53. For example, as indicated by using the arrows A illustrated in FIG. 1, when the operation detecting unit 53 detects a driver's operation of moving his/her hands toward the steering wheel 5, the display controlling unit 55 may display the guidance image 61a in which the hand image 61c approaches the steering-wheel image 61b.

In this manner, the display controlling unit 55 displays the hand image 61c in synchronization with, or substantially in synchronization with the driver's operation of hands, so that it is possible to effectively urge the driver to perform the driving preparation operation for gripping the steering wheel 5.

The display controlling unit 55 may change the steering-wheel image 61b in accordance with a gripping state of the driver for the steering wheel 5. For example, when the gripping determination unit 54 determines that the driver grips the steering wheel 5, the display controlling unit 55 may change the steering-wheel image 61b. Specifically, the display controlling unit 55 may set a color of the steering-wheel image 61b to be red before the driver grips the steering wheel 5, and may change the color into blue after the driver has gripped the steering wheel 5. Thus, the display controlling unit 55 is able to cause the driver to recognize that the steering wheel 5 is reliably gripped and the driving preparation operation has been performed.

As the change of the steering-wheel image 61b, not limited to the above-mentioned change in the color, the display controlling unit 55 may change the steering-wheel image 61b, which had blinked to be displayed before the driver gripped the steering wheel 5, into the steering-wheel image 61b that does not blink after the driver has gripped the steering wheel 5, for example.

The display controlling unit 55 may cause any of the displays 40 to display an image indicating information on a remaining time interval and information on a remaining distance until the driving state is switched into the manual driving, which are acquired by an output of the driving switching unit 51. For example, the display controlling unit 55 may cause the HUD 41 to display a countdown image as the information on the remaining time interval, such as “90 seconds until release of autonomous driving” (not illustrated). The display 40, which displays the information on the remaining time interval, is not limited to the above-mentioned HUD 41, may be the meter display 42, the center display 43, etc.

FIG. 7 is a diagram illustrating one example of the image that indicates information on the remaining distance. As illustrated in FIG. 7, the display controlling unit 55 may combine the road image 61f, which imitates a travelling road, with a goal image 61h, which imitates a finish tape, so as to display the information on the remaining distance. The goal image 61h is displayed, in the road image 61f, at a position corresponding to a position at which the driving state is switched into the manual driving.

Thus, the display controlling unit 55 is able to effectively cause the driver to grasp a timing at which the driving state is switched into the manual driving.

The notification controlling unit 56 informs the user of switching of a driving state of the vehicle 1 from the autonomous driving into the manual driving. For example, the notification controlling unit 56 outputs, via the speaker 74, a sound such as “Autonomous driving is going to be released. Please grip the steering wheel.” before the driving switching unit 51 switches the driving state of the vehicle 1 from the autonomous driving into the manual driving, so as to perform notification on the user. Thus, the notification controlling unit 56 is able to effectively cause the driver to previously recognize the switching of the driving state from the autonomous driving into the manual driving.

When the gaze detecting unit 52 detects that, for example, the driver looks aside, namely, the driver does not direct his/her gaze to the front of the vehicle 1, the notification controlling unit 56 may cause the speaker 74 to output an effect sound that expresses a flow from the rear to the front of the vehicle interior 2, for example. When the gaze detecting unit 52 detects that a gaze of the driver does not direst to the front of the vehicle 1, the display controlling unit 55 may cause the meter display 42 to display the gaze guiding image 61d for guiding the gaze of the driver to the HUD 41 from the meter display 42. Thus, it is possible to urge the driver to look at the front of the vehicle 1.

For example, when the gaze detecting unit 52 detects no gaze so as to estimate that the driver takes a nap, the notification controlling unit 56 may cause the speaker 74 to output a warning sound. Moreover, the notification controlling unit 56 may cause an actuator (not illustrated) attached to the driver's seat to operate, and raises a backrest of the driver's seat or vibrates the driver's seat so as to urge the driver to perform the driving preparation operation for gripping the steering wheel 5.

When the gaze detecting unit 52 estimates that the driver takes a nap, the notification controlling unit 56 may perform the above-mentioned notification using a sound on the user earlier than the case where the driver is awake.

3. Process for Controlling Driver Assistance Apparatus

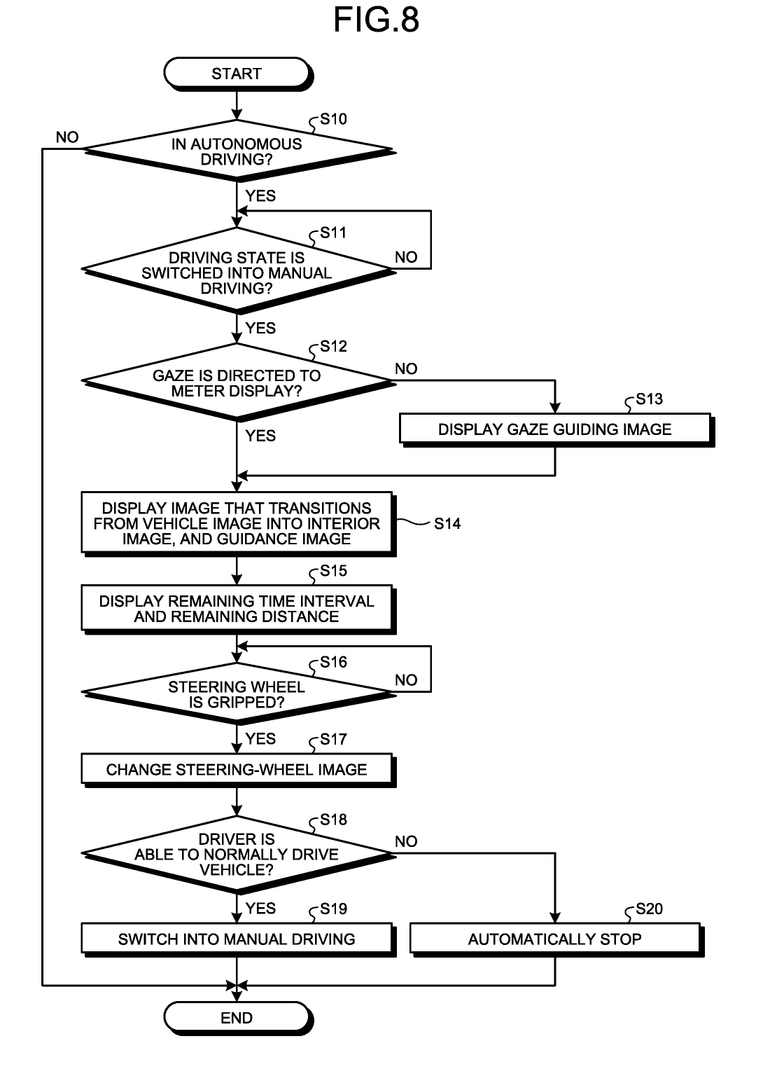

Next, details of a processing procedure to be executed by the driver assistance apparatus 30 will be explained with reference to FIG. 8. FIG. 8 is a flowchart illustrating the processing procedure to be executed by the driver assistance apparatus 30.

As illustrated in FIG. 8, the control unit 50 of the driver assistance apparatus 30 determines whether or not a driving state of the vehicle 1 is the autonomous driving (Step S10). When determining that the driving state of the vehicle 1 is not the autonomous driving (Step S10: No), the control unit 50 skips the following processes.

On the other hand, when determining that the driving state of the vehicle 1 is the autonomous driving (Step S10: Yes), the control unit 50 determines whether or not the driving state is switched into the manual driving from the autonomous driving because a condition for performing the autonomous driving is not satisfied, for example (Step S11).

When determining that the driving state of the vehicle 1 is not switched into the manual driving (Step S11: No), namely, when the autonomous driving is continued, the control unit 50 repeats the process of Step S11. On the other hand, when determining that the driving state of the vehicle 1 is to be switched into the manual driving (Step S11: Yes), the control unit 50 determines whether or not the driver directs his/her gaze to the meter display 42 (Step S12).

When determining that the driver does not direct his/her gaze to the meter display 42 (Step S12: No), the control unit 50 causes any of the displays 40, for example, to which the gaze is directed, to display the gaze guiding image 61d (Step S13).

When determining that the driver directs his/her gaze to the meter display 42 (Step S12: Yes), or after causing any of the displays 40 to display the gaze guiding image 61d in the process of Step S13, the control unit 50 causes the meter display 42 to display an image that transitions from the vehicle image 61e into the interior image 61g, and then causes the meter display 42 to display the guidance image 61a (Step S14).

Next, the control unit 50 causes the display 40 to display information that indicates the remaining time interval and the remaining distance (Step S15). The control unit 50 determines whether or not the driver has gripped the steering wheel 5 (Step S16). When determining that the driver does not grip the steering wheel 5 (Step S16: No), the control unit 50 repeats the process of Step S16.

On the other hand, when determining that the driver has gripped the steering wheel 5 (Step S16: Yes), the control unit 50 changes the steering-wheel image 61b (Step S17). Subsequently, the control unit 50 determines, before the switching into the manual driving, whether or not the driver is able to normally perform the manual driving (Step S18).

When determining that the driver is able to normally perform the manual driving (Step S18: Yes), the control unit 50 switches the driving state of the vehicle 1 from the autonomous driving into the manual driving (Step S19). On the other hand, when determining that the driver is not able to normally perform the manual driving (Step S18: No), the control unit 50 causes the vehicle 1 to automatically stop at a safe position such as a road shoulder (Step S20).

As described above, the driver assistance apparatus 30 according to the embodiment includes: the driving switching unit 51; and the display controlling unit 55. The driving switching unit 51 switches a driving state of the vehicle 1 from autonomous driving into manual driving. The display controlling unit 55 causes, before the driving switching unit 51 switches the driving state of the vehicle 1 from the autonomous driving into the manual driving, the display 40 to display an image that transitions from the vehicle image 61e imitating an exterior of the vehicle 1 into the interior image 61g imitating an interior of the vehicle 1. Thus, it is possible to effectively cause the driver to previously recognize the switching of the state of the vehicle 1 from the autonomous driving into the manual driving.

The display controlling unit 55 causes the display 40 to display the image that transitions from the vehicle image 61e into the interior image 61g, and then causes the display 40 to display the guidance image 61a that urges a driver to grip the steering wheel 5. Thus, it is possible to effectively cause the driver to previously recognize the switching of the state of the vehicle 1 from the autonomous driving into the manual driving to be able to urge the driver to perform a driving preparation operation.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A driver assistance apparatus comprising:
a driving switching unit that switches a driving state of a vehicle from autonomous driving into manual driving; and
a display controlling unit that causes, before the driving switching unit switches the driving state of the vehicle from the autonomous driving into the manual driving, a display to display an image that transitions from a vehicle image imitating an exterior of the vehicle into an interior image imitating an interior of the vehicle.

2. The driver assistance apparatus according to claim 1, wherein the display controlling unit causes the display to display the image that transitions from the vehicle image into the interior image, and then causes the display to display a guidance image that urges a driver to grip a steering wheel.

3. The driver assistance apparatus according to claim 2, wherein the guidance image includes:
a steering-wheel image that imitates the steering wheel; and
an image that indicates an operation of gripping the steering-wheel image.

4. The driver assistance apparatus according to claim 3, wherein the display controlling unit emphasizes and displays, in the steering-wheel image, vicinity of positions corresponding to portions of the steering wheel to be gripped.

5. The driver assistance apparatus according to claim 3, further comprising:
an operation detecting unit that detects an operation of the driver performed on the steering wheel, wherein
the display controlling unit displays, when the operation detecting unit detects a driver's operation of moving his/her hands toward the steering wheel, the guidance image in which a hand image approaches the steering-wheel image, the hand image imitating hands of the driver.

6. The driver assistance apparatus according to claim 4, further comprising:
an operation detecting unit that detects an operation of the driver performed on the steering wheel, wherein
the display controlling unit displays, when the operation detecting unit detects a driver's operation of moving his/her hands toward the steering wheel, the guidance image in which a hand image approaches the steering-wheel image, the hand image imitating hands of the driver.

7. The driver assistance apparatus according to claim 3, further comprising:
a gripping determination unit that determines whether or not the driver has gripped the steering wheel, wherein
the display controlling unit changes the steering-wheel image when the gripping determination unit determines that the driver has gripped the steering wheel.

8. The driver assistance apparatus according to claim 4, further comprising:
a gripping determination unit that determines whether or not the driver has gripped the steering wheel, wherein
the display controlling unit changes the steering-wheel image when the gripping determination unit determines that the driver has gripped the steering wheel.

9. The driver assistance apparatus according to claim 5, further comprising:
a gripping determination unit that determines whether or not the driver has gripped the steering wheel, wherein
the display controlling unit changes the steering-wheel image when the gripping determination unit determines that the driver has gripped the steering wheel.

10. The driver assistance apparatus according to claim 6, further comprising:
a gripping determination unit that determines whether or not the driver has gripped the steering wheel, wherein
the display controlling unit changes the steering-wheel image when the gripping determination unit determines that the driver has gripped the steering wheel.

11. The driver assistance apparatus according to claim 2, further comprising:
another display in addition to the display that displays the guidance image; and
a gaze detecting unit that detects a gaze of the driver, wherein
the display controlling unit causes, when the gaze detecting unit detects that the gaze is directed to the other display, the other display to display a gaze guiding image that guides the gaze from the other display to the display that displays the guidance image.

12. The driver assistance apparatus according to claim 3, further comprising:
another display in addition to the display that displays the guidance image; and
a gaze detecting unit that detects a gaze of the driver, wherein
the display controlling unit causes, when the gaze detecting unit detects that the gaze is directed to the other display, the other display to display a gaze guiding image that guides the gaze from the other display to the display that displays the guidance image.

13. The driver assistance apparatus according to claim 4, further comprising:
another display in addition to the display that displays the guidance image; and
a gaze detecting unit that detects a gaze of the driver, wherein
the display controlling unit causes, when the gaze detecting unit detects that the gaze is directed to the other display, the other display to display a gaze guiding image that guides the gaze from the other display to the display that displays the guidance image.

14. The driver assistance apparatus according to claim 1, wherein the display controlling unit causes the display to display an image that indicates information on at least one of a time interval and a distance until the driving state of the vehicle is switched from the autonomous driving into the manual driving.

15. The driver assistance apparatus according to claim 2, wherein the display controlling unit causes the display to display an image that indicates information on at least one of a time interval and a distance until the driving state of the vehicle is switched from the autonomous driving into the manual driving.

16. The driver assistance apparatus according to claim 3, wherein the display controlling unit causes the display to display an image that indicates information on at least one of a time interval and a distance until the driving state of the vehicle is switched from the autonomous driving into the manual driving.

17. The driver assistance apparatus according to claim 4, wherein the display controlling unit causes the display to display an image that indicates information on at least one of a time interval and a distance until the driving state of the vehicle is switched from the autonomous driving into the manual driving.

18. A driver assistance method comprising:
switching a driving state of a vehicle from autonomous driving into manual driving; and
causing, before the driving state of the vehicle is switched in the switching from the autonomous driving into the manual driving, a display to display an image that transitions from a vehicle image imitating an exterior of the vehicle into an interior image imitating an interior of the vehicle.
